(19) United States
(12) Patent Application Publication
(10) Pub. No.: US 2022/0007082 A1
(43) Pub. Date: Jan. 6, 2022

(54) Generating Customized Video Based on Metadata-Enhanced Content

(71) Applicant: Beyondo Media Inc., San Mateo, CA (US)

(72) Inventors: Tetsuo Okuda, Tokyo (JP); Immanuel Joseph Martin, Tokyo (JP); Tatsuyuki Sakamoto, Funabashi (JP)

(21) Appl. No.: 17/366,712

(22) Filed: Jul. 2, 2021

Related U.S. Application Data
(60) Provisional application No. 63/047,834, filed on Jul. 2, 2020.

(51) Int. Cl. H04N 21/81; H04N 21/2187; H04N 21/84; G06N 20/00; H04N 21/845; G06T 13/20

(52) U.S. Cl. CPC H04N 21/816; H04N 21/2187; H04N 21/84; G06T 13/20; H04N 21/8455; H04N 21/8456; G06N 20/00

(57) ABSTRACT

In one embodiment, a method includes receiving video, three-dimensional (3D) motion data, and location data from image capture devices that captured video during an event. One or more metadata tags may be applied to the video during key moments in the video. The metadata tags may be provided through user input or automatically generated through analysis of the video by a machine-learning model. 3D motion graphics may be generated for the key moments based on actions taking place during the event. The actions may be determined by analyzing the video, the metadata tags, and the 3D motion data. Finally, a composite video comprising at least a portion of the video annotated with the 3D motion graphics may be generated and provided for download or as a video stream.

### PRIORITY

This application claims the benefit, under 35 U.S.C. § 119(e), of U.S. Provisional Patent Application No. 63/047,834, filed 2 Jul. 2020, which is incorporated herein by reference.

### BACKGROUND

Currently, users filming live events with traditional acquisition devices such as camcorders or mobile devices must undergo a complicated and lengthy process in order to obtain final edited videos that can be viewed and shared. It takes significant time to edit these recorded events and the software and other tools to do so are often complicated and expensive. Most consumers do not have the time or budget to devote to purchasing and learning how to use these tools nor invest the many hours needed in order to produce final edited works. With traditional tools there is no way to easily add metadata to the recorded video in order to automate the editing and post-production process.

### SUMMARY OF PARTICULAR EMBODIMENTS

In particular embodiments, the described system creates a method for users to capture video of any genre of event with a mobile device and for users—or an artificial intelligence (“AI”) system, as described herein—to apply metadata to those videos that indicate important moments. The metadata also adds information about the event that may drive overlaying displays of content related data. Then, based on, for example, the metadata and genre of event and metadata indicating information about the event, the described system may automatically create edited versions of the videos composited with event-specific data-driven graphical layers (also referred to as “skins”) into a final edited work that is ready to be viewed and shared by users, such as on the cloud.

In particular embodiments, the described system provides for both user driven metadata tagging for initial accuracy as well as an interface to accept AI/machine learning-based data that can be collected and analyzed over time.

In particular embodiments, the described system's hybrid approach leveraging both user driven metadata tagging and AI/machine learning-based tagging means users may take advantage of both the speed and accuracy of user-driven tagging, while at the same time, take advantage of AI/machine learning-driven tagging that can be offered as data is stored and analyzed over time.

In particular embodiments, a context-driven user interface (“UI”) and user experience (“UX”) also makes the described system unique in its ability to provide a rich user experience with appropriate skins and graphical elements composited automatically in the final video works.

The embodiments disclosed above are only examples, and the scope of this disclosure is not limited to them. Particular embodiments may include all, some, or none of the components, elements, features, functions, operations, or steps of the embodiments disclosed above.

### BRIEF DESCRIPTION OF THE DRAWINGS

FIG. 1 illustrates an architecture for generating customized video based on metadata-enhanced content.

FIG. 2 illustrates an example method for generating customized video based on tags provided as user input.

FIG. 3 illustrates an example method for generating customized video based on tags automatically determined and applied using machine learning.

FIG. 4 illustrates an example graphical user interface for selection of tags while recording video.

FIG. 5 illustrates an example graphical user interface for portraying a 3D virtual representation of a scene captured while recording video.

FIG. 6 illustrates an example graphical user interface for portraying a customized 3D virtual representation of a scene captured while recording video.

FIG. 7 illustrates an example graphical user interface for portraying graphical overlays, augmented reality (AR) information, and other graphic elements representing 3D motion within a 3D virtual representation of a scene captured while recording video.

FIG. 8 illustrates an example computer system.

### DESCRIPTION OF EXAMPLE EMBODIMENTS

Particular embodiments disclosed herein may be designed to address specific problems or omissions in the current state of the art.

Consumers to date suffer from a lack of ability to easily record, edit, and share video in a high quality format. Often, recorded video of events remain archived and not easily accessible on difficult-to-edit tape or digital media that requires high-end editing and graphics to be shared and watched.

Editing video of recorded events via traditional means requires many cumbersome steps, complex software, and a significant amount of time. Previously processes were entirely manual and the manual editor must make many decisions about what content should be included in the final edited works. In addition, in today's content-driven world, one version of an edited work is not always sufficient. Those interested in capturing and curating video of events therefore may consider it necessary to produce several different edited versions depending on the audience or distribution platform. In order to accomplish the task of creating multiple versions of edited works, much editing effort has to be duplicated making for a very inefficient process.

In particular embodiments, the described system provides a mobile device-based solution enabling consumers to create high quality, information- and graphics-rich productions for sharing and viewing across distributed networks. In particular embodiments, the system requires little to no previous editing experience or expertise and yet the built-in editing and motion graphics may make end-product videos appear as if they were recorded and produced by a professional. The powerful and flexible tagging functionality may allow a user to create a custom-edited video with minimal direct interaction.

In addition, content-based skins, which may include graphical layouts for the video or the ability to create brief “highlights” of events captured in the video, make it ideal to share the events with people who could not attend an event in person.

The following will describe an example involving an amateur soccer match. Users of the described system may capture video (e.g., by recording video and/or live-streaming video) of the match using their mobile device's camera. A single user or multiple users may capture video of the match and the described system may synchronize all of the recordings and/or live-streams together. The described application executing on the mobile device may determine the type of event being captured and provide a customized UI and tag set interface to the user(s). While capturing the video, the users may manually add tags to the video as needed. Any number of cameras—or users permitted only to tag the video (e.g., “tag-only users”) could contribute at the same time. The described system may then apply techniques including, but no limited to proprietary algorithms to make tag recommendations during video capture to recommend the most accurate and compelling tags for the match.

Users may also user the described system's automatic machine learning-based tagging. Before or during the video capture, the described system may create a three-dimensional (“3D”) model of the event filming location, which may include the physical space as well as motion elements in the video. As an example, the application may recognize physical locations such as actual stadiums and arenas and recognize the type of sports event being captured. The described system may then track detected motions and identify actions captured on video and store it in a machine-learning repository for ongoing analysis. Based on the machine learning-based tracking of motion and/or identification of actions, the described system may be able to track activities detected during an event, such as goals, fouls, penalties, cards, etc. for a soccer match, and automatically apply the appropriate tag to the appropriate point in the video. In particular embodiments, location information associated with detected motions and/or identified actions may be used to further analyze video and help with accurate detection of event details (e.g., which team made a goal). In particular embodiments, with the 3D motion data collected, 3D- and augmented reality- (AR) effects can be added to the video. When video capture is finished and the video files saved and uploaded, for example, to a distributed network, the described system may provide users extensive freedom to create any number of completed edited versions of the game based on whatever settings, or individual preferences they have. Users can, with the selection of a minimal number of settings, initiate creation of a highlight video that includes only those elements that are relative to the user's preferences. For example, those preferences may be based on the user-driven tags, machine learning-based recommendations, or fully automated machine learning-based tags.

The completed videos may then be ready to be shared via distributed network to the audience of the user's choosing.

Particular embodiments disclosed herein may provide one or more of the following results, effects, or benefits:

Leveraging the advanced computing and graphics processing ability of mobile devices, a user of the described system may add tags (e.g., metadata) to video recordings and/or live streams and generate edited works based on the metadata. The user-driven tags may simultaneously provide an ideal foundation for capturing accurate metadata about events in the videos that can be analyzed by the described system's machine-learning system.

The described system leverages a unique hybrid of user-driven tagging and machine learning-based tagging. The user-driven tagging may be in the form of crowd sourced user input. Users capturing an event on video may check in with the mobile application of the described system, enabling their inputs to be synchronized together. The application may analyze the various inputs from multiple camera and user tag streams. The application may then make intelligent recommendations for the events in the video that can be tagged. The user can may then optionally accept the suggested tagging recommendations or override them, based on the user's settings.

In particular embodiments, the described system may also incorporate a unique machine-learning system that captures both 3D spatial data about the event location and the motion data that represents action(s) taking place during the event being captured. Upon initiation of the video capture process, the application may attempt to identify a location from which video is being captured to determine if it is already a known location with an existing virtual (3D) representation. If it is a known location, then each camera may be mapped to its location in the virtual representation according to its position at the event location. The 3D spatial data may be used to capture events in the video for editing and post-production purposes. In addition, once the type of event is identified, the application may track motion data—such as, in a sports event, the motion of the ball, a player following the ball, or important activities during the event such as a goal. Furthermore, as the physical location may have a virtual 3D map, the application may predict activities such as fouls, penalties, etc.

As another example, for events such as a live music event, the application may identify the type of action a performer is doing such as singing, dancing, or using a specific instrument, in order to apply the appropriate tag (metadata) to that element of the video. Edited works based on the context of the event can easily be created leveraging the described system's machine-learning capabilities.

The described captured video(s) may be combined or layered with a variety of graphical elements such as skins (preset screen graphic layouts), dynamic metadata driven displays of event-related information, or real-time 3D graphics for a professional broadcast-like viewing experience.

In particular embodiments, events may be captured on the user's mobile device. The added metadata may be attached to the video files. The resulting files may be stored in one or more distributed networks and data storage facilities. Based on the robust backup system, there may no need to take up limited storage space on users' local mobile devices with large video files. From the convenience of the user's mobile device, they may create edited works from the cloud-based data and then share the edited works to the audience of their choosing.

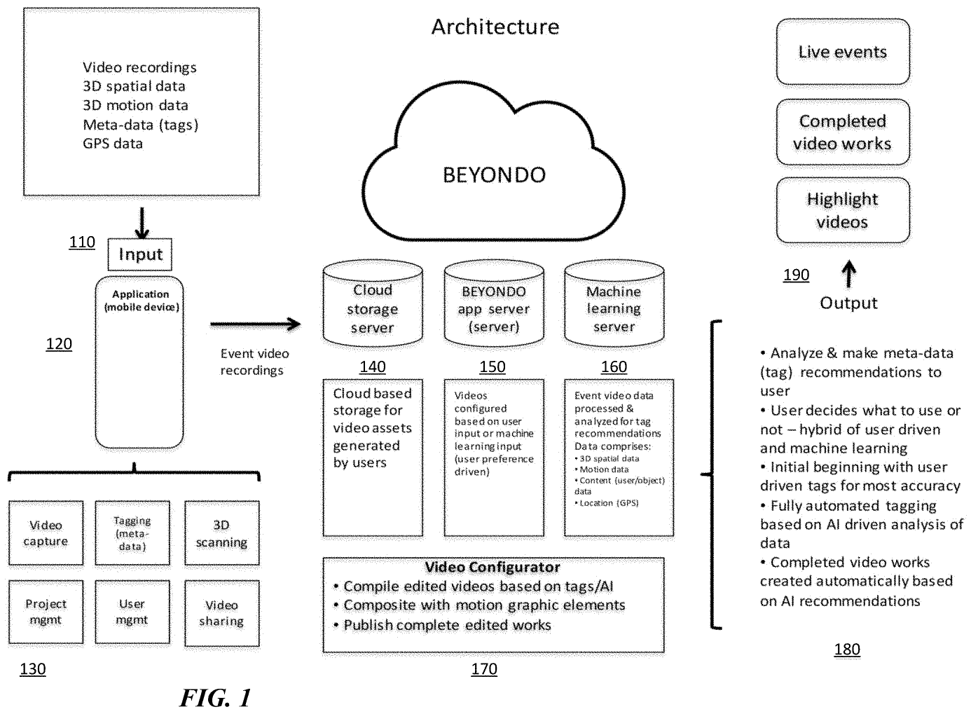

Particular embodiments disclosed herein may be implemented using one or more example architectures. An example architecture is illustrated in FIG. 1.

The application is designed to serve a broad range of use cases. The described system may be compatible with any live event to be captured by an individual using a mobile device, the video of which the user wishes to create completed edited works with a high degree of professional quality. Examples of use cases are capturing sports games and events, business and marketing events, school lectures and events, cultural events and performances, musical events as well as news and other entertainment, etc.

The mobile application 120 of the described system leverages mobile devices to capture the live events. The devices also serve to add the associated metadata 110 to the video recordings which are used in order to create the final edited works.

Example functionality 130 on the mobile device may include of the following main components:
Video capture: Recording and/or live-streaming the event using the camera of the mobile device.
Tagging (metadata): adding metadata to the video file leveraging user-entered tags for accuracy.
3D scanning: Using the camera or other sensors of the mobile device to create a 3D model of an event as well as to track motion based events in the video.
Project management: Create and manage projects which consist of captured events in various categories.
User management: Manage users and permissions to view recorded captured events.
Video sharing: Share captured events using the cloud service of the user's choosing.

After video is captured, the resulting files may be stored in a cloud storage server 140. Files may be initially stored on the user's mobile device and then, according to the preference of the user, uploaded to the cloud. The files may then be available for manipulation by the described system to create finished edited video works. Cloud-based storage assets may be managed as needed to include deletion of older un-used files, transfer of files to individual users for the purpose of individualized management, or control of cloud-based assets.

Videos may be configured based on user input tags or machine-learning input at an application server 150. User entered metadata (tags) may be more accurate. In particular embodiments, the application may leverage this data to make recommendations at later stages for tags based on analysis of this data over time.

A rich variety of data may be collected for machine-learning analysis at a machine-learning server 160. The data may include the user-entered tags (metadata) which indicate important moments in captured events. 3D spatial data may be captured and a virtual representation of the physical location of the event may be created to gather data for analysis. In particular embodiments, once 3D virtual representations of event locations and individuals or objects are created and/or recognized, the physical counterparts of these items may be tracked and analyzed to be combined with other collected data collected to make tag recommendations or enable automated tagging of actions and/or activities in the video.

Edited videos may be compiled in a video configurator 170 using tags and machine-learning according to rules based on the genre/type of event that is being captured as well as user preferences. These edited videos may be composited with motion graphic elements, 2D or 3D or 3D AR information. Information gathered while capturing the event that is relevant for the event may be displayed and incorporated into final edited works. Example information may include game information, speaker information, etc. Completed edited works may be published and can be shared and viewed according to the user's preferences.

For output 180 the application of the described system may analyze and make metadata (tag) recommendations to the user. The user may then decide which tags to use. This is a hybrid approach of user-driven tagging and machine learning. The system may leverage user-driven tags to create an accurate data set of important activities detected during the captured events. Fully automated tagging based on machine-learning analysis of the data may be initiated once a critical mass of data has been collected by the system. In particular embodiments, the application may become smarter and more accurate over time as more data is collected and analyzed. Completed video works can then be created on an entirely automated basis based on the AI recommendations.

Specific outputted works 190 may be in the form of complete recordings and/or video streams of entire events composited with information and motion graphic elements, edited shorter versions of events in the form of highlight videos, or AI-based creations exported based on user settings and AI editing recommendations. In particular embodiments, the AI-based exports may allow for rapid creation of edited meaningful content ready for viewing and consumption by the audience of the user's preference.

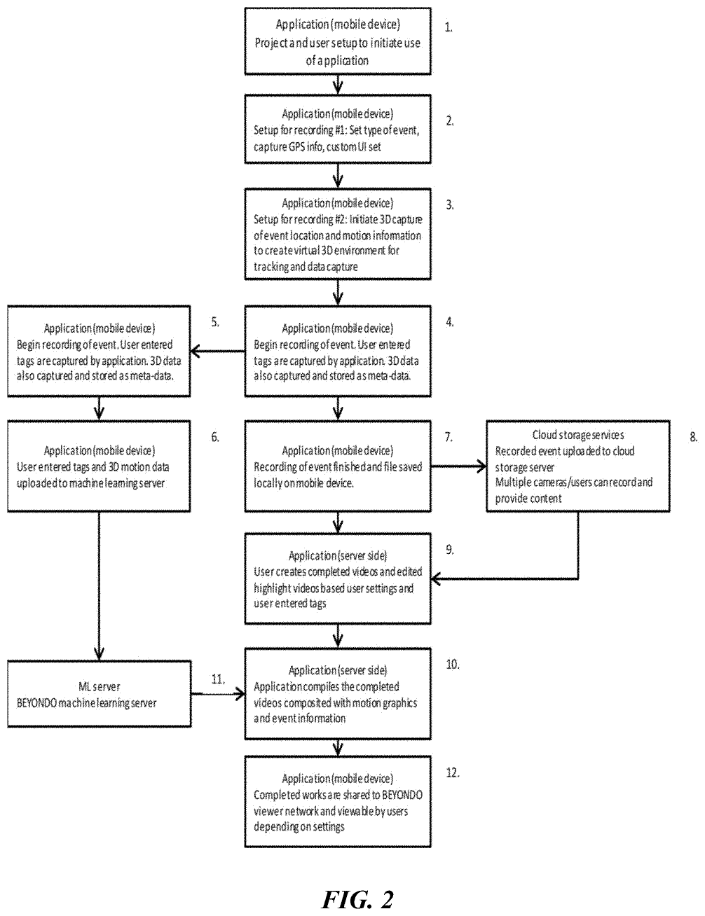

Particular embodiments disclosed herein may be implemented using one or more example processes. A first example process for manual tag input with data collection for machine learning is illustrated in FIG. 2. The following description of steps refers to the steps illustrated in FIG. 2.
1. User creates an account and logs into application
2. Application identifies current filming location, e.g., from GPS data, to determine if previous event was filmed at this site. If previous event found, application suggests to user type of event to be filmed and presets loaded into application such as custom UI and menu set.
3. Application scans scene to be filmed to create point cloud used to create 3D virtual environment. This data may be used to create virtual stadiums, 3D overlays for informational displays, motion graphics, or virtual advertisements. As much as possible, players are identified to be tracked and that information stored for analysis by application.
4. The user initiates video capture of the event. As key moments in the event occur the user may choose tags from a menu that identify the type of event. This information may be used for editing of the game or creation of highlight videos. In addition, tracked 3D data is stored to be used and analyzed by the application to aid in editing and tracking of events while filming.
5. Tag data and 3D data are captured by the application and stored as metadata for the video.
6. Tag and 3D data are uploaded to the machine-learning server for analysis for future use.
7. The user terminates the capture of the event and the application then saves the recorded video along with any associated metadata locally on the mobile device.
8. The application then uploads the recorded event to the cloud storage server. If there were multiple cameras recording the event, these additional recordings will also be uploaded to the cloud server.
9. The user can now create edited versions of the recording which include both long-form edited versions as well as shorter highlight versions. These versions are created using the user-entered tags and compiled according to the user's preference for which elements they would like to include in the final edited piece.
10. The application compiles the final edited versions of the recorded events based on the user-entered preferences. The final edited works may include 3D motion graphics, informational overlays about the event such as, for example, game score, team information, location information, etc.
11. The machine-learning server stores information about the recorded event and analyzes for future use for automatic tagging and tracking of actions and activities.
12. The application publishes the completed edited version of the recorded event and it is now available for members of the application's community to watch and share.

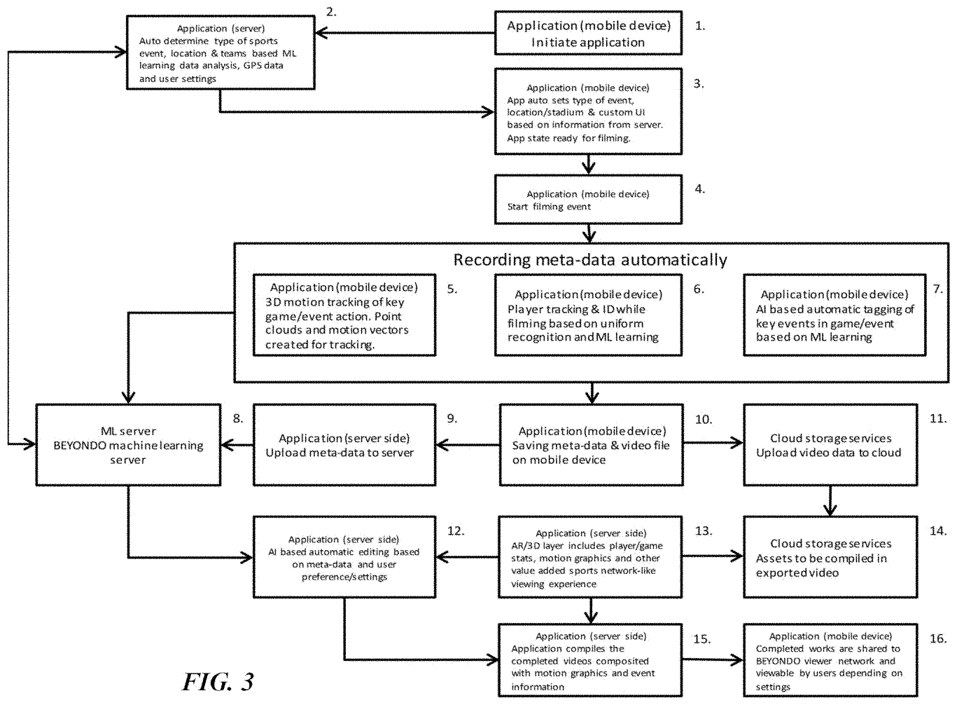

A second example process for full artificial intelligence/machine-learning and three-dimensional implementation is illustrated in FIG. 3. The following description of steps refers to the steps illustrated in FIG. 3.
1. User creates an account and logs into application
2. The application, in conjunction with the machine-learning server, determines the type of event to be filmed based on GPS and historical data.
3. Based on data from machine-learning server the application automatically sets the type of event to be filmed and serves up a custom UI and menu specifically for the genre of event. The application is now ready to start filming the event.
4. The user initiates video capture of the event.
5. The application loads previously used 3D point cloud and motion tracking information to automatically map the camera to the physical location as well as automatically track and record tags for key events that occur in event.
6. Application automatically tracks players (if the captured event is sports game) and their action(s) throughout the video. The information may be stored as tags (metadata) to create edited and highlight versions of the recording.
7. Using the machine-learning server the application automatically tags key moments in the recorded event.
8. The machine-learning server gathers and stores information about the recorded events that the application captures. This data is analyzed for patterns so that automatic tagging and tracking of events in recording can occur. The application leverages AI for automatic tagging and subsequent automatic editing of completed edited videos.
9. The application uploads metadata (tags and other related data about recorded event) to the machine-learning server.
10. Metadata from recorded event is saved to the local mobile device before being uploaded to the machine-learning server.
11. The application uploads the recorded event files to the cloud storage server.
12. The application automatically creates fully edited long-form or short highlight versions of the recording based on AI tags and user preferences.
13. The application creates the 3D assets to be used as motion graphics, information overlays about the event as well as 3D assets to be included in the final recording such as virtual stadiums and player avatars.
14. Video assets are compiled in the cloud storage server in preparation for creation of final edited versions of event recording.
15. The application automatically creates the final edited versions of the recording using the machine learning-created tags, 3D assets for a professional sports network-like viewing experience and original event recordings stored in the cloud storage server.
16. The final completed edited versions are published to the application's viewer network based on the user preferences. Users can view the edited versions as members of a team, followers of a team, or as public users browsing publicly shared content.

In particular embodiments, capturing the event may comprise live-streaming the event while simultaneously recording the event. In such embodiments, metadata tags may be applied by the user using the application or automatically applied by the machine-learning server.

Particular embodiments may repeat one or more steps of the example process(es), where appropriate. Although this disclosure describes and illustrates particular steps of the example process(es) as occurring in a particular order, this disclosure contemplates any suitable steps of the example process(es) occurring in any suitable order. Moreover, although this disclosure describes and illustrates an example process, this disclosure contemplates any suitable process including any suitable steps, which may include all, some, or none of the steps of the example process(es), where appropriate. Furthermore, although this disclosure describes and illustrates particular components, devices, or systems carrying out particular steps of the example process(es), this disclosure contemplates any suitable combination of any suitable components, devices, or systems carrying out any suitable steps of the example process(es).

Particular embodiments disclosed herein may be implemented in relation to different example use cases.

As described herein, the described system has a broad range of uses for recording many different types of events and using metadata to create completed edited works.

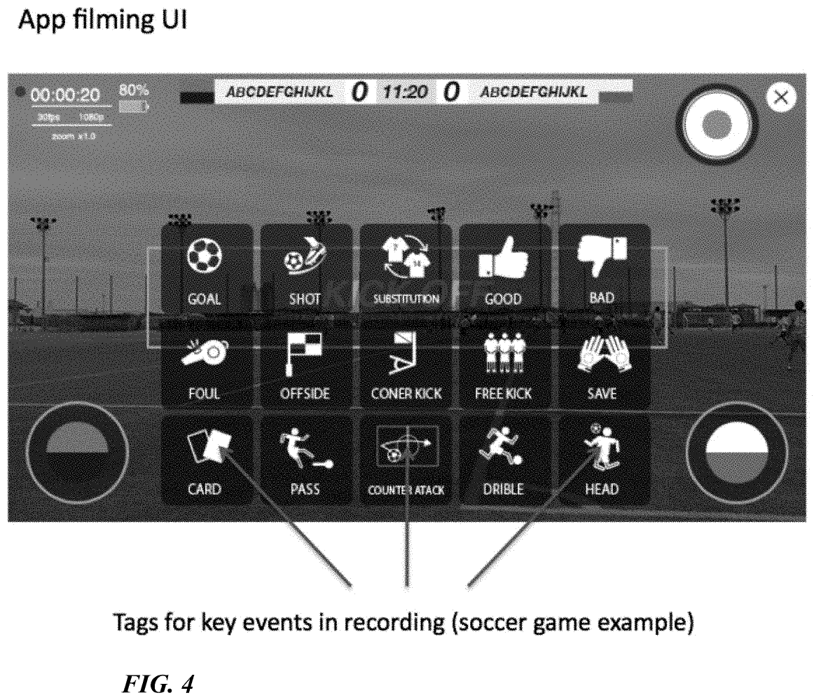

In the case of an amateur sports event such as an amateur soccer game, the application will detect (along with user input) the type of sports event to be recorded and then a custom interface will be set along with a custom set of tags (metadata). For example, selecting an amateur soccer match will bring up a menu with all of the amateur soccer specific related events that could occur in a match. The user may then initiate recording and while recording the user may select tag types (metadata) from the application UI as they occur, shown in FIG. 4.

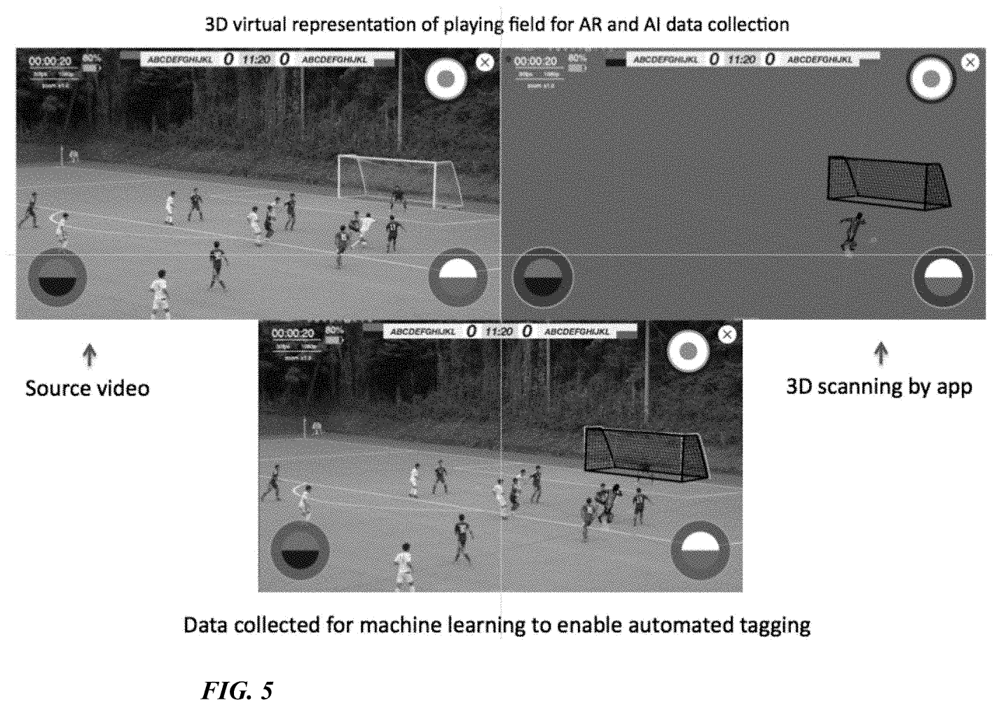

Those tags associated with the key events in the game may then be attached to the video file as metadata. The application may also make a 3D virtual representation of the playing field including opposing goals, teams and will follow, track and capture action(s) by analysis of the 3D data by the application. The application will be able to distinguish between different elements such as stadium, opposing goal areas, players and ball, shown in FIG. 5.

The application then, based on the actions and/or activities detected through machine-learning analysis over time, may add additional metadata to the video to aid in the post-processing and editing of the final video. For example if it identifies a stadium, historical data from previous games/events at that stadium can be leveraged and used to overlay relevant graphical information over the final image. In this example a single user such as a team member, records the game and tags key events such as goals by the player, other highlights, and important moments. After recording is finished and the file is saved on the mobile device, the user may upload the recorded game to the cloud. Once uploaded, the user may create custom highlight videos that only show the elements of the game that are important to the user. This is accomplished in the application by selecting the tag elements desired to be highlight and then selecting the games to include highlights from. These could be important plays, dramatic moments, goals, and other moments that were highlighted. These completed finished works may be created with just a few selections in the UI and made available instantly to be shared.

For another example, such as a semi-professional league playing in a large stadium, the operation would be similar but would leverage the described system's machine-learning capabilities and automatic tagging functionality extensively.

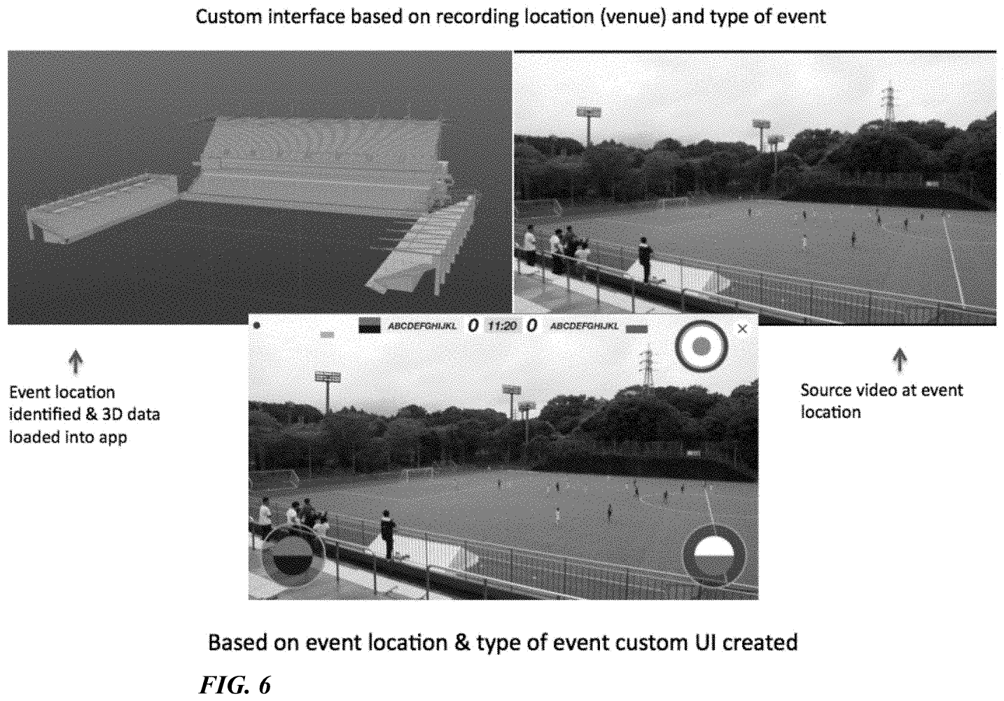

Since the event would be being recorded at an existing stadium, preset 3D data could be loaded for camera mapping. Then once the type of game is selected, a custom interface would be displayed based on the event type, location, and schedule in season, shown in FIG. 6.

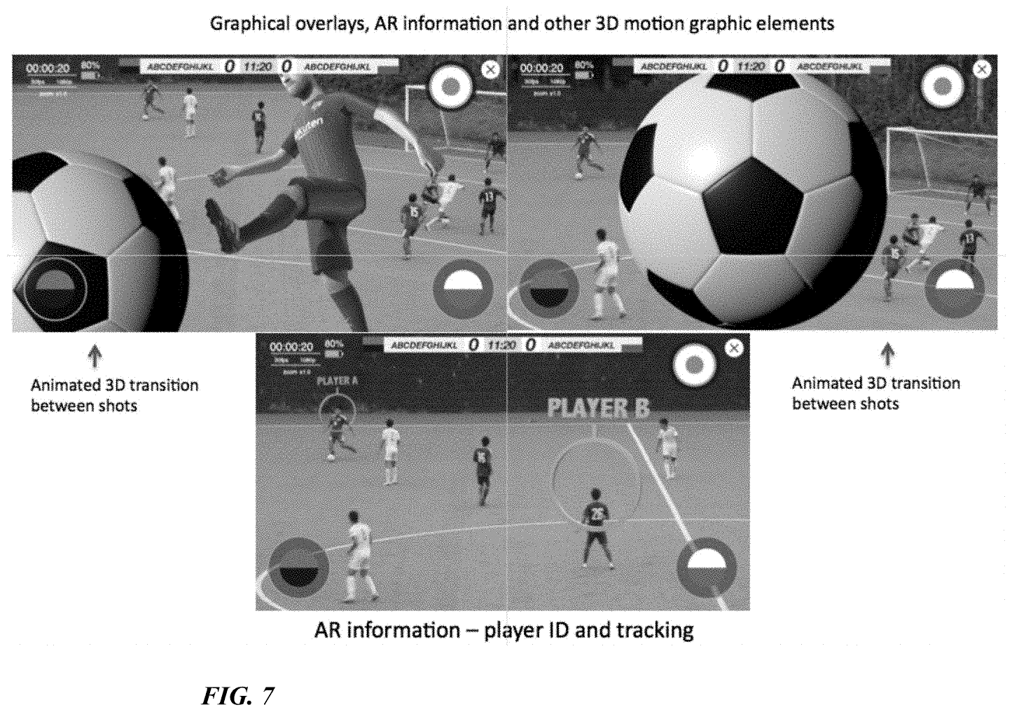

Then since teams and viewers will want to focus on the game as much as possible the described system may automatically track and tag the important moments in the game using its machine-learning engine. This may be accomplished by analysis of historic data from games based on tracking the motion of key events as identified by their 3D motion and positional data. The application creates point clouds and 3D geometry of game content and action(s) and analyzes that information to track appropriate data. Users may still be able to manually tag moments in the event. In addition, multiple users (devices) can be filming the same game and add information/tags from the applications tagging interface, to the data-set for that match simultaneously. This information may include close-up views of important actions, a close-up of a player or even crowd and audience response. All of these information sources may be synced automatically and linked to the specific game. Rich sets of graphical overlays, AR information, and other 3D motion graphic elements may be composited in order to provide a network sports event experience, shown in FIG. 7.

Once the event recording has finished, the user(s) will then save the recording as part of a project and then that project may be uploaded to the cloud. The described system's machine learning-based tagging can be used to create any combination of custom versions of the game as well as complete game recording versions. The application may do this by identifying a variety of tagged key elements in the recording and allowing the user to choose which combination of key events/highlights they would like to use to create the custom version of the recording. These events may then be viewable by anyone with access to the described system, providing the content owner has made them public.

In another example, such as a user recording a college lecture, the process would be similar. The user would select the type of event, for example short form scheduled course lecture, preparation for an exam, long form lecture, etc. Appropriate tag menu would be applied along with an appropriate skin/UI for showing related data, such as custom tags for the type of event being recorded, relevant graphic overlays such as timer, text, and motion graphics. The recording would be started, and then as key points are discussed, the appropriate tag would be added by the user so that the user could easily reference the important or key points in the lecture. The end-user in this case could either be the student recording the lecture for their own benefit or the professor recording for use by their students. Once recording is finished, the user may upload the files for immediate sharing and viewing by the appropriate audience. Edited versions can be created on the fly based on the tag sets (metadata) selected. For example the professor may select the key moments of a lecture related to a specific topic for preparation for an exam from the application UI and then export a custom version of the recording based on that information.

In another example, such as user generated video content for video sharing sites, the user would select the type of event they are recording (for example a weather event, local news event, cultural event, etc.) and then an appropriate menu of tags would be displayed. The user then records the event noting the appropriate tags as important elements of the event occur. Skins (or customized graphical overlays) can be applied to give the videos a professional look, and then when finished the recordings are saved and uploaded to the cloud. Once in the cloud they can be automatically edited based on the tags and then shared within minutes to the media of the users choosing. Again, content specific tags can be selected for composing the custom edited version of the video. These could be tags such as interview key moments, funny key moments, dramatic key moments—in effect, any kind of tag that can be used to describe elements in the recording for future reference. The user selects the tags from the application's UI and then exports the custom edited video based on their selections. The application composes the video combining the clips into a final video.

Underlying foundational concepts and terms of art relied upon may relate to one or more of the following:

Persons developing the described system may need to be familiar with video recording technology and formats as well as video encoding and decoding technology. They would need to be familiar with cloud-based technologies and services including data storage, video processing/encoding and video streaming from the cloud to mobile devices. They may require experience with databases for user and application-related data management.

In all example embodiments described herein, appropriate options, features, and system components may be provided to enable collection, storing, transmission, information security measures (e.g., encryption, authentication/authorization mechanisms), anonymization, pseudonymization, isolation, and aggregation of information in compliance with applicable laws, regulations, and rules. In all example embodiments described herein, appropriate options, features, and system components may be provided to enable protection of privacy for a specific individual, including by way of example and not limitation, generating a report regarding what personal information is being or has been collected and how it is being or will be used, enabling deletion or erasure of any personal information collected, and/or enabling control over the purpose for which any personal information collected is used.

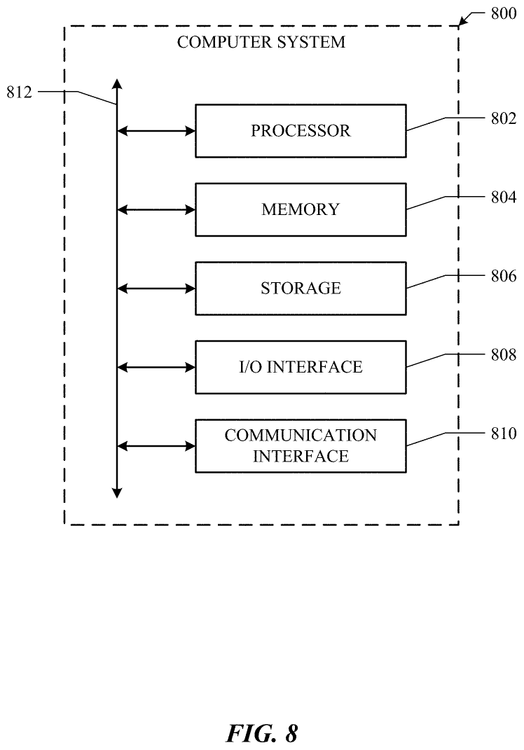

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-court (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

What is claimed is:

1. A method comprising, by a computing server:
receiving video, three-dimensional (3D) motion data, and location data from each of a plurality of image capture devices that captured video during an event;
identifying one or more metadata tags applied to the video during key moments in the video;
generating 3D motion graphics for the key moments based on actions taking place during the event, wherein the actions were determined by analyzing the video, the metadata tags, and the 3D motion data;
generating a composite video comprising at least a portion of the video annotated with the 3D motion graphics; and
providing the composite video for download.

2. The method of claim 1, wherein the one or more metadata tags were received from at least one of the image capture devices.

3. The method of claim 1, further comprising:
analyzing, using a machine-learning model, the video to identify the key moments and at least one action associated with each of the key moments; and
generating the one or more metadata tags based on the identified key moments and actions.

4. The method of claim 1, further comprising:
identifying, for each of the image capture devices, a physical location of the mobile computing device; and
mapping each image capture device to a location in a 3D model of the event according to its position at the event location, wherein the 3D motion graphics were generated in accordance with the 3D model of the event.

5. The method of claim 4, further comprising:
capturing, based on the physical location of each of the image capture devices, a 3D scan of the event location; and
creating, based on the 3D scan, a 3D model of the event.

6. The method of claim 4, wherein the event takes place at a known location, further comprising retrieving a 3D model of the event.

7. The method of claim 1, further comprising:
identifying one or more people appearing in the video during one of the key moments, wherein the actions were determined based at least part on the identified one or more people.

8. One or more computer-readable non-transitory storage media embodying software that is operable when executed to:
receive video, three-dimensional (3D) motion data, and location data from each of a plurality of image capture devices that captured video during an event;
identify one or more metadata tags applied to the video during key moments in the video;
generate 3D motion graphics for the key moments based on actions taking place during the event, wherein the actions were determined by analyzing the video, the metadata tags, and the 3D motion data;
generate a composite video comprising at least a portion of the video annotated with the 3D motion graphics; and
provide the composite video for download.

9. The media of claim 8, wherein the one or more metadata tags were received from at least one of the image capture devices.

10. The media of claim 8, wherein the software is further operable when executed to:
analyze, using a machine-learning model, the video to identify the key moments and at least one action associated with each of the key moments; and generate the one or more metadata tags based on the identified key moments and actions.

11. The media of claim 8, wherein the software is further operable when executed to:
identify, for each of the image capture devices, a physical location of the mobile computing device; and
map each image capture device to a location in a 3D model of the event according to its position at the event location, wherein the 3D motion graphics were generated in accordance with the 3D model of the event.

12. The media of claim 11, wherein the software is further operable when executed to:
capture, based on the physical location of each of the image capture devices, a 3D scan of the event location; and
create, based on the 3D scan, a 3D model of the event.

13. The media of claim 11, wherein the event takes place at a known location, wherein the software is further operable when executed to retrieve a 3D model of the event.

14. The media of claim 8, wherein the software is further operable when executed to:
identify one or more people appearing in the video during one of the key moments, wherein the actions were determined based at least part on the identified one or more people.

15. A system comprising:
one or more processors; and
one or more computer-readable non-transitory storage media coupled to one or more of the processors and comprising instructions operable when executed by one or more of the processors to cause the system to:
receive video, three-dimensional (3D) motion data, and location data from each of a plurality of image capture devices that captured video during an event;
identify one or more metadata tags applied to the video during key moments in the video;
generate 3D motion graphics for the key moments based on actions taking place during the event, wherein the actions were determined by analyzing the video, the metadata tags, and the 3D motion data;
generate a composite video comprising at least a portion of the video annotated with the 3D motion graphics; and
provide the composite video for download.

16. The system of claim 15, wherein the processors are further operable when executing the instructions to:
analyze, using a machine-learning model, the video to identify the key moments and at least one action associated with each of the key moments; and
generate the one or more metadata tags based on the identified key moments and actions.

17. The system of claim 15, wherein the processors are further operable when executing the instructions to:
identify, for each of the image capture devices, a physical location of the mobile computing device; and
map each image capture device to a location in a 3D model of the event according to its position at the event location, wherein the 3D motion graphics were generated in accordance with the 3D model of the event.

18. The system of claim 17, wherein the processors are further operable when executing the instructions to:
capture, based on the physical location of each of the image capture devices, a 3D scan of the event location; and
create, based on the 3D scan, a 3D model of the event.

19. The system of claim 17, wherein the event takes place at a known location, wherein the processors are further operable when executing the instructions to retrieve a 3D model of the event.

20. The system of claim 15, wherein the processors are further operable when executing the instructions to:
identify one or more people appearing in the video during one of the key moments, wherein the actions were determined based at least part on the identified one or more people.
